(19) United States
(12) Patent Application Publication
(10) Pub. No.: US 2003/0053497 A1
(43) Pub. Date: Mar. 20, 2003

(54) Laser support structure

(75) Inventor: William B. Joyce, Basking Ridge, NJ (US)

Correspondence Address: HITT GAINES & BOISBRUN P.C., P.O. BOX 832570, RICHARDSON, TX, 75083, US

(73) Assignee: Agere Systems Optoelectronics Guardian Corp.

(21) Appl. No.: 09/952,694

(22) Filed: Sep. 14, 2001

(51) Int. Cl. H01S 3/04

(52) U.S. Cl. 372/36

(57) ABSTRACT

A laser support structure and method of mounting a laser in a module. The laser support structure is used in a laser module to support a laser in alignment with an optical fiber. The support structure comprises a frame having a base portion, and a mounting portion opposed to the base portion with a space therebetween. A dielectric layer to which the laser may be attached is suspended from the mounting portion and extends partially into the space between the mounting portion and the base portion. As the dielectric layer expands or contracts, it does so within the space between the mounting portion and the base portion with minimal displacement of the laser.

### FIELD OF THE INVENTION

The invention relates to semiconductor lasers, and more particularly to mounting of lasers within a module.

### BACKGROUND OF THE INVENTION

A laser module consists of a platform on which a laser is positioned, and a case which surrounds the positioned device and provides protection thereto. Typically, the laser is used in conjunction with an optical fiber which is disposed through the case wall. Proper alignment of the optical fiber with the laser in the laser module is important for the performance of the device. Thermal mismatch of module parts greatly affects the alignment in conventional module configurations. Therefore, device failure may be high and devices may only be functional within limited temperature ranges.

Conventional laser modules are made from composite metals such as Kovarg®, a borsilicate glass containing iron, nickel, cobalt and manganese, or copper tungsten (CuW). These materials are chosen primarily to match the thermal expansion coefficient of the module components with that of optical fibers and dielectric components. These composite metals have deficiencies which may include poor thermal conductivity, undesirable mechanical characteristics which may cause fracturing during laser mounting, and unpredictable and anisotropic thermal expansion coefficients. Additionally, the thermal expansion coefficient matching of materials only exists for a limited temperature range. The more materials contained in the module, the more difficult it is to match coefficients of expansion.

Accordingly, there is a need for a laser module in which alignment of optical fibers with the laser is not adversely affected by expansion and contraction of module components during temperature changes.

### SUMMARY OF THE INVENTION

Embodiments of the invention provide a laser support structure and method of mounting a laser in a module that may reduce alignment problems found in conventional designs. The laser support structure is used in a laser module to support a laser in alignment with an optical fiber. The support structure comprises a frame having a base portion, and a mounting portion opposed to the base portion with a space therebetween. A dielectric layer to which the laser may be attached is suspended from the mounting portion and extends partially into the space between the mounting portion and the base portion. As the dielectric layer expands or contracts, it does so within the space between the mounting portion and the base portion, with minimal displacement of the laser. Therefore, the alignment of the laser and the optical fiber remains substantially constant during temperature changes. The laser support structure may also include a heat spreader attached to a side of the dielectric layer facing the base portion. A space exists between the heat spreader and the base portion so that the dielectric layer may expand with minimal displacement of the laser.

### DESCRIPTION OF THE DRAWINGS

The invention is best understood from the following detailed description when read with the accompanying drawings.

FIG. 1 depicts a cross-sectional view of a prior art laser module.

FIGS. 2A-C depict a cross-sectional views and top view, of a laser module portion according to an illustrative embodiment of the invention.

### DETAILED DESCRIPTION OF THE INVENTION

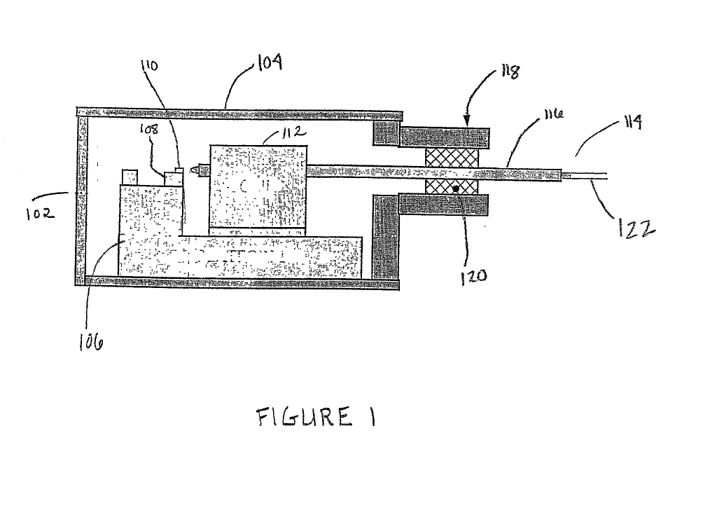

FIG. 1 depicts a cross-sectional view of a prior art laser module 102. Module 102 has a platform 106 that supports a dielectric layer 108. Platform 106 may contain one or more components. Laser 110 is supported by dielectric layer 108. A clip 112 is also supported by platform 106 and holds in place an optical fiber assembly 114. Optical fiber assembly 114 contains optical fiber 122 within a sleeve 116. A case 104 provides protection to module 102. Case 104 may have a snout 118 to support optical fiber assembly 114. Solder 120 may be used to attach fiber assembly 114 to snout 118. As dielectric layer 108 expands and contracts, it displaces laser 110 with respect to optical fiber 122. Due to thermal mismatch, expansion of clip 112, platform 106, and case 104 may differ from that of dielectric layer 108, thereby causing misalignment of optical fiber 122 with laser 110.

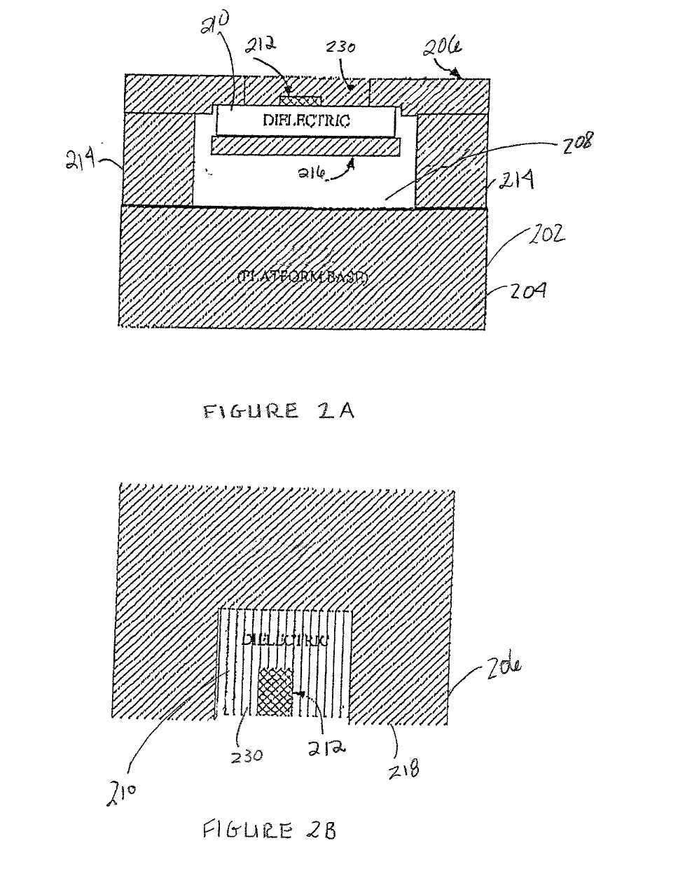

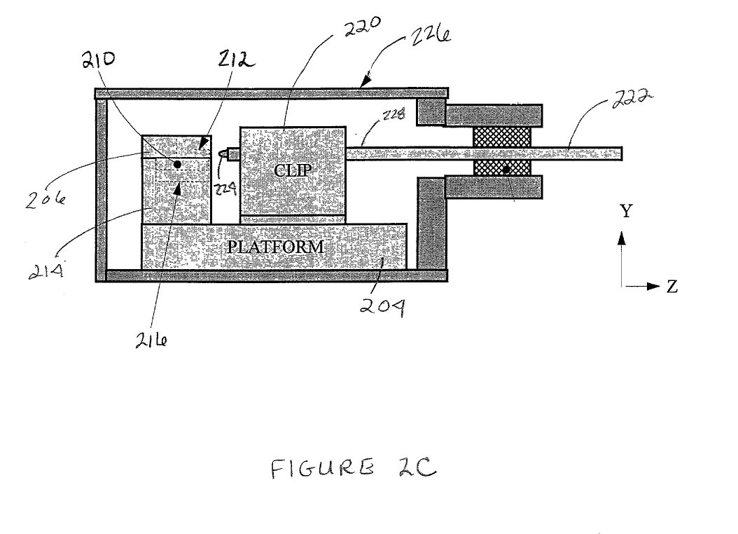

FIGS. 2A-C depict cross-sectional views and top view of an illustrative embodiment of a laser support structure. The structure depicted includes a frame 202 having a base portion 204 and a mounting portion 206 with a space 208 therebetween. Mounting portion 206 is more clearly shown by the top view of the support structure 202 depicted in FIG. 2B. In the embodiment illustrated in FIG. 2B, a slot 230 in mounting portion 206, extends inward from an outer edge 218 of mounting portion 206. As shown in FIGS. 2A-C, laser 212 is attached to dielectric layer 210, and dielectric layer 210 is attached to mounting portion 206. Where components are described herein as being “attached to”, “supported by” or the like, one or more additional layers may exist between the components or the components may be in direct contact with one another. The additional components may be provided for example, to improve adhesion or enhance performance of the device. Mounting portion 206 may be supported by support portion 214 of frame 202 to maintain a space between mounting portion 206 and base portion 204. Support portion 214 maintains sufficient space between components suspended from mounting portion 206 and base portion 204 without interfering with other laser module components or their function. FIG. 2C also depicts a case 226 surrounding the structure.

As dielectric layer 210 expands or contracts, it does so into space 208. Expansion of other components within the module is similar to expansion that may affect the position of the optical fiber. Accordingly, the laser will remain substantially aligned with the optical fiber during such variations. Because the expansion of the dielectric component now has minimal effect on the alignment of the fiber with the laser, components that do have an effect on laser or fiber position may have coefficients of thermal expansion that do not match that of the dielectric layer. Advantageously, this increases the possible materials that may be used in the structure, thereby optimizing module characteristics.

As can be seen from FIGS. 2A-C, the coefficient of thermal expansion of frame 202, any portions thereof, clip 220 or any other fiber positioning component, no longer has to match that of dielectric 210, as the dielectric component is no longer a significant factor in the alignment of laser 212 with fiber assembly 222. (Fiber assembly 222 may include, for example, an optical fiber 224 surrounded by a sleeve 228.) Because the materials of these components do not have to be matched to the dielectric layer coefficient of thermal expansion, materials having a wider range of mechanical and thermal properties may be utilized. In an illustrative embodiment, the frame comprises one or more metals, one or more metal alloys or a combination thereof. Examples of frame materials include but are not limited to alumina, borsilicate glass containing iron, nickel, cobalt and manganese, and CuW. In a further illustrative embodiment, the coefficients of thermal expansion of a fiber positioning component and the dielectric layer differ by a factor of greater than about 1.2. In yet another embodiment, the component and layer coefficients of thermal expansion differ by a factor of greater than about 1.1. Examples of materials that may fall within these ranges are BeO, a dielectric having a coefficient of thermal expansion of 6.9×10⁻⁶, used with Kovar®, a metal having a coefficient of thermal expansion of 5.3×10⁻⁶.

The frame may be a single component including base, mounting and support portions. Alternatively, any of these portions may be formed separately and then assembled to form the frame.

In an illustrative embodiment, support portion 214 comprises one or more parts which may be at any angle to base 204 but are preferably at right angles thereto. Similarly, support portion 214 is preferably at right angles to mounting portion 206. Support portion 214 may comprise a single component with an opening to allow for a path between an optical fiber and laser 212.

The space between dielectric layer 210 and base 204 must be at least large enough to accommodate expansion of dielectric layer 210 so that dielectric layer 210, or any components attached thereto, will not be compressed against base 204 during temperature variations.

In an exemplary embodiment of the invention, a heat spreader 216 is attached to dielectric layer 210. Heat spreader 216 may be attached directly to dielectric layer 210 or there may be one or more layers therebetween. The purpose of heat spreader 216 is to transfer heat away from the laser. Heat spreader 216 may comprise for example, gold or copper.

The invention further includes a method of mounting a laser in a module wherein

the laser is to be aligned with an optical fiber. The method comprises suspending a dielectric layer from the frame to allow expansion and contraction of the dielectric layer within a space between the dielectric layer and the frame, such that the alignment of the laser and the fiber remains substantially constant.

Further disclosed is a laser module comprising a laser support structure as described above.

While the invention has been described by illustrative embodiments, additional advantages and modifications will occur to those skilled in the art. Therefore, the invention in its broader aspects is not limited to specific details shown and described herein. Modifications, for example, to the shape of the frame and materials of the laser support structure, may be made without departing from the spirit and scope of the invention. Accordingly, it is intended that the invention not be limited to the specific illustrative embodiments but be interpreted within the full spirit and scope of the appended claims and their equivalents.

Claimed is:

1. A laser support structure used in a laser module to support a laser in alignment with an optical fiber, the support structure comprising:
a frame having a base portion, and a mounting portion opposed to the base portion, with a space therebetween; and
a dielectric layer to which the laser may be attached, the dielectric layer suspended from the mounting portion and extending partially into the space between the mounting portion and the base portion;
wherein the dielectric layer can expand and contract within the space between the mounting portion and the base portion with minimal displacement of the laser such that the alignment of the laser and the optical fiber remains substantially constant.

2. The laser support structure of claim 1 wherein the space between the base and mounting portions is maintained by a frame support portion.

3. The laser support structure of claim 2 wherein the base portion comprises a substantially flat component, the support portion comprises one or more parts extending from a base portion surface and at an angle thereto, the mounting portion comprises a substantially flat component having a slot therein extending inward from an outer edge, the mounting portion supported by the one or more support parts and at an angle thereto such that the space is maintained between the mounting and base portions, wherein the dielectric layer spans the slot of the mounting portion and is attached to the mounting portion.

4. The support structure of claim 3 wherein the dielectric layer is attached to the mounting portion on a side of the mounting portion facing the base portion.

5. The laser support structure of claim 1 wherein the dielectric layer is soldered to the frame.

6. The laser support structure of claim 1 wherein the frame comprises one or more materials selected from the group consisting of metals and metal alloys.

7. The laser support structure of claim 1 further comprising a heat spreader attached to the dielectric layer.

8. The laser support structure of claim 7 wherein the heat spreader comprises a material selected from the group consisting of gold and copper.

9. The laser support structure of claim 1 wherein the frame is a single component.

10. The laser support structure of claim 1 used in a laser module having a fiber positioning component, wherein the coefficient of thermal expansion of the fiber positioning component differs from the coefficient of thermal expansion of the dielectric layer.

11. The laser support structure of claim 10 wherein the coefficients of thermal expansion differ by at least a factor of about 1.2.

12. The laser support structure of claim 11 wherein the coefficients of thermal expansion differ by at least a factor of about 1.1.

13. A laser module comprising a laser support structure according to claim 1.

14. A semiconductor device comprising a laser module wherein the laser module comprises a laser support structure according to claim 1.

15. A method of mounting a laser in a module, wherein the laser is to be aligned with an optical fiber, the method comprising:
suspending a dielectric layer from a frame;
the frame having a base portion and a mounting portion opposed to the base portion, with a space therebetween;
the dielectric layer suspended partially into the space to allow expansion and contraction of the dielectric layer within the space such that the alignment of the laser and the fiber remains substantially constant.

16. The method of claim 15 further comprising attaching a heat spreader to the dielectric layer.

17. The method of claim 16 wherein the heat spreader comprises a material selected from the group consisting of gold and copper.
